(19) United States
(12) Patent Application Publication
(10) Pub. No.: US 2002/0100143 A1
(43) Pub. Date: Aug. 1, 2002

(54) Furniture hinge with an improved fastening object

(76) Inventor: Cheol-Soo Pyo, Seoul (KR)

Correspondence Address: HARNESS, DICKEY & PIERCE, P.L.C., P.O. BOX 828, BLOOMFIELD HILLS, MI, 48303, US

(21) Appl. No.: 10/062,888

(22) Filed: Jan. 31, 2002

(30) Foreign Application Priority Data
Jan. 31, 2001 (KR) 2001-0004444

(51) Int. Cl. E05D 5/00

(52) U.S. Cl. 16/383

(57) ABSTRACT

Disclosed is a furniture hinge with an improved fastening object. In the furniture hinge, an offset fastening peg has a sectional shape corresponding to the shape of the through holes and protrudes from an underside of the fastening flanges. A fastening element includes a head having a tool inserting recess formed at an upper surface thereof, a shaft downwardly extending from an underside of the head to become one body with the head, and anchoring ribs laterally protruding from a lower end portion of an outer periphery surface of the shaft to become one body with the shaft. From this structure, the furniture hinge is capable of easily being mounted to and released from the door body.

### BACKGROUND OF THE INVENTION

1. Field of the Invention

The present invention relates to a furniture hinge with an improved fastening object.

2. Description of the Related Art

Conventionally, there many techniques related to the furniture hinge have been disclosed. For example, door fastening member constructed as a hinge cup for furniture hinges, has been proposed in U.S. Pat. No. 5,577,297 issued to Horst Lautenschlager on Nov. 26, 1996.

This conventional furniture hinge includes a hinge cup, an elongated support arm and a hinge control lever.

The hinge cup is fitted into a main fastening recess which is formed at a rear surface of a door body. Fastening flanges protrude from an upper edge of both sides of the hinge cup and they are engaged with an inner surface of the door body. Offset fastening pegs detachably protrude from undersides of the fastening flanges. The offset fastening pegs are inserted into an auxiliary fastening recess, which is formed at the rear surface of the door body, and fixed by a fastening element. The fastening element is rotatably inserted into through holes of the fastening flanges, respectively. Accordingly, the furniture hinge having the structure as described above is cable of being mounted and released from the hinge cup without using a special tool.

However, in order to install at the underside of the fastening flanges, the offset fastening pegs must be employed. Further, the fastening element in order to be installed at the fastening flanges must be used by an actual disk. Consequently, it iss complex to mount and release the fastening element at door body.

### SUMMARY OF THE INVENTION

The present invention solves the foregoing problems. It is an object of the present invention to provide a furniture hinge with an improved fastening object which is easily cable of being mounted and released from the door body.

In order to achieve the above objects, the present invention provides a furniture hinge with an improved fastening object in which fastening flanges protrude from an upper edge of a hinge cup, and a plurality of through holes are formed at an upper surface of the fastening flanges, wherein the fastening object comprises:

offset fastening pegs having a sectional shape corresponding to the shape of the through holes, and protruding from an underside of the fastening flanges; and

a fastening element including a head having a tool inserting recess formed at an upper surface thereof, a shaft downwardly extending from an underside of the head to become one body with the head, and anchoring ribs laterally protruding from a lower end portion of an outer periphery surface of the shaft to become one body with the shaft,

when the shaft of the fastening element is rotated after inserted into the through hole to pass through an interior of the offset fastening peg, the anchoring ribs are forcedly fitted into an interior of the door body.

The through holes are divided into a first area and a second area. The first area is formed in an arc shape and the second area extends from the discontinuous position of the first area in a key groove shape.

A stopping projection outwardly protrudes from the head of the fastening element. A plurality of stoppers protrude from an upper surface of the fasten flanges.

As described above, in the furniture hinge with an fastening object according to the preferred embodiment of the present invention, offset fastening peg protrudes from an underside of the fastening flange. A fastening element comprises a head, a shaft downwardly protruding from an underside of the head to become one body with the head, and anchoring rib protruding from a lower end portion of an outer periphery surface of the shaft to become one body with the shaft. Through holes having a first area are formed as a arc shape and a second area continuously extends from circumferential ends of the first area in a key-groove shape. Further, a stopping projection outwardly protrudes from an edge of the head, a plurality of stoppers protrude from an upper surface of the fasten flanges. With this structure, the furniture hinge is easily cable of being mounted and released from the door body.

### BRIEF DESCRIPTION OF THE DRAWINGS

The above objects and other characteristics and advantages of the present invention will become more apparent by describing in detail a preferred embodiment thereof with reference to the attached drawings, in which:

FIG. 1 shows a furniture hinge having an improved fastening object according to a preferred embodiment of the present invention;

FIG. 2 is a plan view of a hinge cup as shown in FIG. 1;

FIG. 3 is a partially sectional view taken along line I-I of FIG. 1;

FIG. 4 shows the state before a fastening element is fitted into a door body;

FIG. 5 shows the fastening element fitted in the door body;

FIG. 6 is a sectional view taken along line II-II of FIG. 3 showing the state before the fastening element is fitted into the door body; and

FIG. 7 is a sectional view taken along line II-II of FIG. 3 showing the fastening element fitted in the door body.

### DETAILED DESCRIPTION OF THE PREFERRED EMBODIMENTS

Hereinafter, a furniture hinge with an improved fastening object according to a preferred embodiment of the present invention will be explained in more detail with reference to the accompanying drawings.

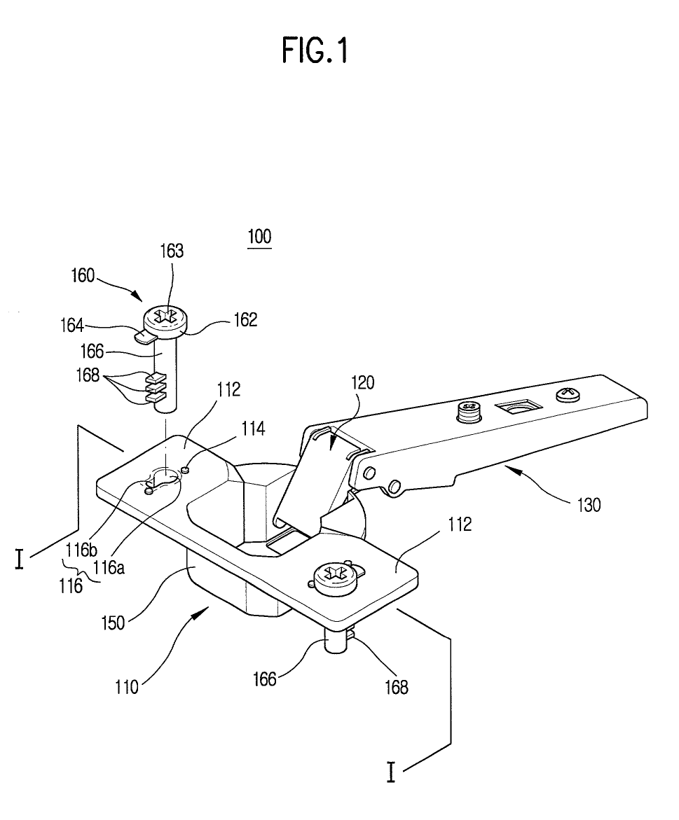

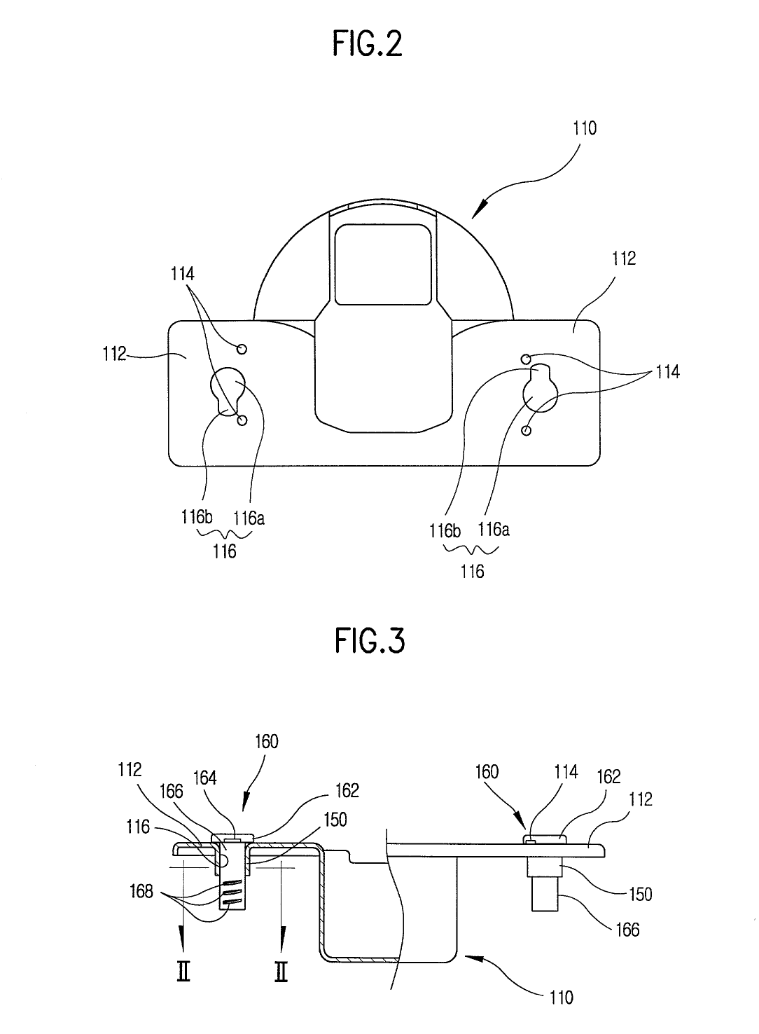

Referring to FIGS. 1 to 3, a furniture hinge 100 includes a hinge cup 110, an elongated support arm 130 and a hinge control lever 120 which is disposed there between and is assembled to become one body with them.

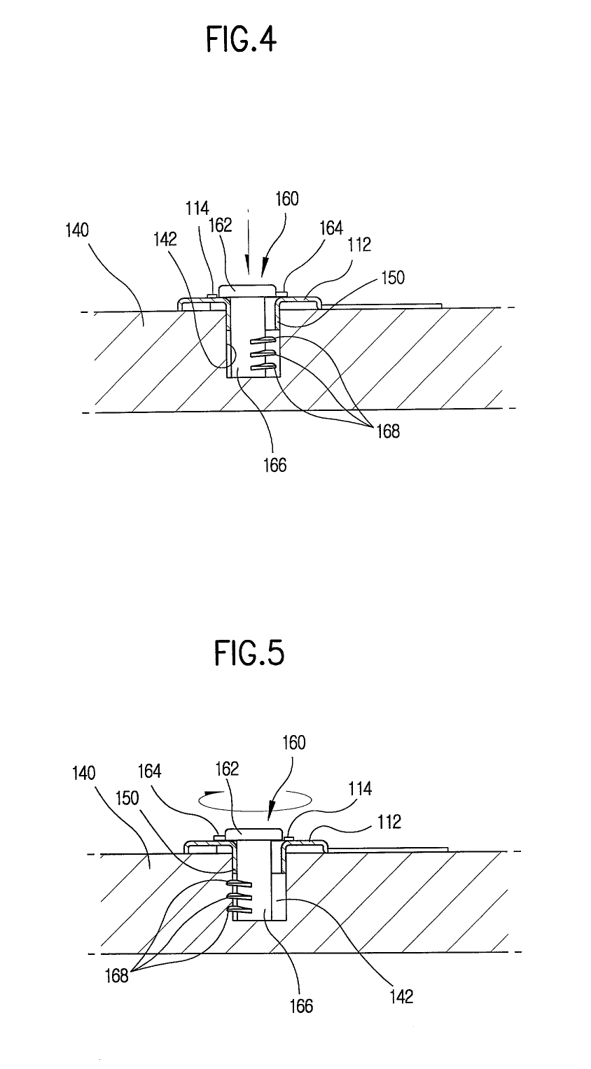

Fastening flanges 112 protrude from an upper edge of the hinge cup 110 which is fitted in a door body 140 (referred to FIGS. 4 to 7). A plurality of stoppers 114 upwardly protrude from an upper surface of the fasten flanges 112. Preferably, the stoppers 114 are opposed to each other. A plurality of through holes 116 are formed through an upper surface of the fastening flanges 112. The through holes 116 are divided into the first area 116a and the second area 116b. At this time, a first area 116a is formed as an arc shape and a second area 116b continuously extends from circumferential ends of the first area 116a in a key-groove shape.

The fastening object according to the preferred embodiment of the present invention comprises offset fastening pegs 150 and a fastening element 160. The offset fastening pegs 150 have a sectional shape corresponding to the shape of the through holes 116. The offset fastening pegs 150 protrude from an underside of the fastening flanges 112. Preferably, the offset fastening pegs 150 are formed by using the drawing process.

A fastening element 160 includes a head 162, a shaft 166 and a plurality of anchoring ribs 168. A tool inserting recess 163 is formed at an upper surface of the head 162. The tool(not shown) is inserted into the tool inserting recess 163 in order to rotate the fastening element 160. A shaft 166 downwardly extends from an underside of the head 163 to become one body with the head 163. Anchoring ribs 168 protrud from a lower end portion of an outer periphery surface of the shaft 166 to become one body with the shaft 166. The anchoring ribs 168 extend from the outer periphery surface of the shaft 166 in parallel with each other. The anchoring rib 168 has a pointed edge in order to be firmly inserted into the door body 140. A stopping projection 164 outwardly protrudes from an upper edge of the head 162 of the fastening element 160. The stopping projection 164 of the head 162 has a function for incicating a rotating state of the anchoring ribs 168. The stopper projection 164 rotates between the stoppers 114 in a 180-degree arc so as to limit a turning radius of the anchoring ribs 168.

when the shaft 166 of the fastening element 160 is rotated after inserted into the through hole 116 to pass through an interior of the offset fastening peg 150, the anchoring ribs 168 are forcedly fitted into an interior of the door body 140.

Hereinafter, the operation of the furniture hinge with an improved fastening object according to the preferred embodiment of the present invention as above will be described in detail with reference drawings FIGS. 4 to 7.

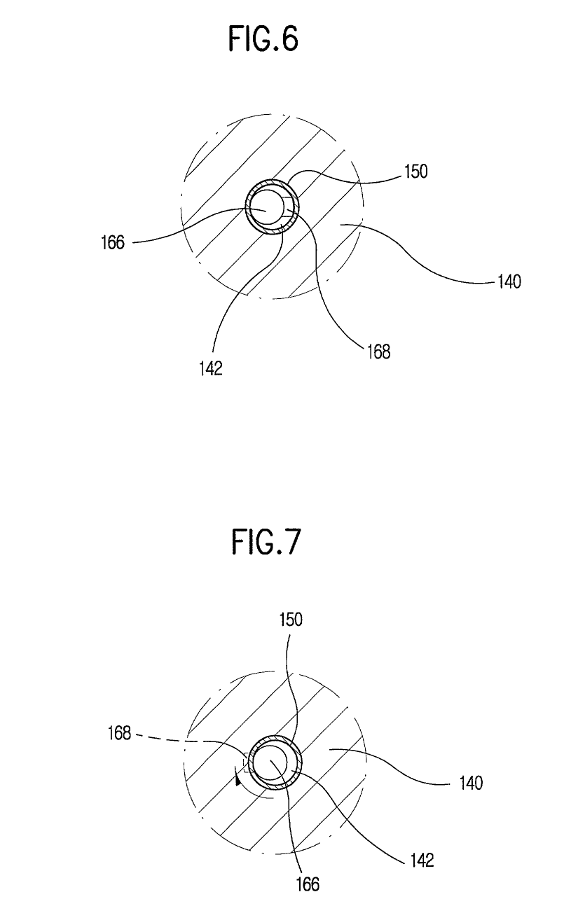

At first, when a user wants to mount the furniture hinge 100 to the door body 140, as shown in FIGS. 4 and 6, main fastening recesses (not shown) and auxiliary recesses 142 are formed on a backside of the door body 142. The hinge cup 110 of the furniture hinge 100 is inserted into the main recesses, so that the fastening flanges 112 are brought into contact with the backside of the door body 140, respectively. At this time, each of the offset fastening pegs 150 are inserted into the auxiliary recesses 142. Thereafter, the shaft 166 of the fastening element 160 is inserted into the through hole 116 to pass through an interior of the offset fastening pegs 150. More specifically, the shaft 166 is inserted into the first area 116a of the through hole 116 and the anchoring ribs 168 are inserted into the second area 116b of through hole 116. At this time, the anchoring ribs 168 are positioned in the auxiliary fastening recesses 142, respectively.

The offset fastening pegs 150 prevent the shaft 116 of the fastening element 160 from being freely. The shaft 116 of the fastening element 160 can be prevented from moving free by the offset fastening pegs 150. Further, the offset fastening pegs 150 support the fastening element 160 and prevent it from inclining.

Also, as shown in FIGS. 5 and 7, a worker inserts a typical driver (not shown) into the tool inserting recess 163, and thereafter begins to rotate the driver in a clockwise direction or in a counterclockwise direction. Thereafter, the anchoring ribs 168 are rotated together with the shaft 166. As a result, the anchoring ribs 168 are moved from the interior of the fastening recesses 142 to the outside. At this time, the anchoring ribs 168 are forcedly inserted in the door body 140. Meanwhile, the rotating angle of the fixing ribs 168 are limited by the stopping projection 164 and the stoppers 114. Since the highest anchoring rib 168 is supported at the lower end portion of the offset fastening peg 150, the fastening element 160 does not release from the offset fastening peg 150.

As described above, in the furniture hinge with an improved fastening object according to the preferred embodiment of the present invention, the offset fastening pegs 150 protrude from an underside of the fastening flanges 112. The fastening element 160 comprises the head 162, the shaft 166 and the anchoring ribs 168 protruding from a lower end portion of an outer periphery surface of the shaft 166 to become one body with the shaft 166. From this structure, the furniture hinge having the structure as described above is capable of being mounted and released from the door body.

While the present invention has been particularly shown and described with reference to particular embodiments thereof, it will be understood by those skilled in the art that various changes in form and details may be effected therein without departing from the spirit and scope of the invention as defined by the appended claims.

What is claimed is:

1. A furniture hinge with an improved fastening object in which fastening flanges protrude from an upper edge of a hinge cup, and a plurality of through holes are formed at an upper surface of the fastening flanges, wherein the fastening object comprises:
offset fastening pegs having a sectional shape corresponding to the shape of the through holes, and protruding from an underside of the fastening flanges; and
a fastening element including a head having a tool inserting recess formed at an upper surface thereof, a shaft downwardly extending from an underside of the head to become one body with the head, and anchoring ribs laterally protruding from a lower end portion of an outer periphery surface of the shaft to become one body with the shaft,
when the shaft of the fastening element is rotated after inserted into the through hole to pass through an interior of the offset fastening peg, the anchoring ribs are forcedly fitted into an interior of the door body.

2. The furniture hinge as claimed in claim 1, wherein the through holes are divided into a first area and a second area, the first area is formed as an arc shape and the second area continuously extends from circumferential ends of the first area in a key-groove shape.

3. The furniture hinge as claimed in claim 1, further comprising a stopping projection outwardly protruding from an upper edge of the head, and a plurality of stoppers protrude from an upper surface of the fasten flanges.
